(19) United States
(12) Patent Application Publication
(10) Pub. No.: US 2023/0416537 A1
(43) Pub. Date: Dec. 28, 2023

(54) Colorful Low-Emissivity Paints for Space Heating and Cooling Energy Efficiency

(71) Applicant: The Board of Trustees of the Leland Stanford Junior University, Stanford, CA (US)

(72) Inventors: Yi Cui, Stanford, CA (US); Zhenan Bao, Stanford, CA (US); Yucan Peng, Menlo Park, CA (US); Jiancheng Lai, Mountain View, CA (US)

(21) Appl. No.: 18/213,626

(22) Filed: Jun. 23, 2023

Related U.S. Application Data
(60) Provisional application No. 63/355,193, filed on Jun. 24, 2022.

(51) Int. Cl. C09D 5/33; C09D 7/61; C09D 7/40; B82Y 30/00; C09D 5/03; C09D 175/02; B05D 7/00

(52) U.S. Cl. CPC C09D 5/004; C09D 7/61; C09D 7/70; B82Y 30/00; C09D 5/031; C09D 5/035; C09D 175/02; B05D 7/52; B05D 2530/00; B05D 2601/08

(57) ABSTRACT

A bilayer coating for thermal management has a bottom layer composed of aluminum microflakes dispersed in a Nitrile Butadiene Rubber-co-Urea (NBR-U) polymer binder, and a top layer composed of nanoparticle pigments in the NBR-U polymer binder. The top layer has a transmittance larger than 0.7 at IR wavelengths, and the bottom layer has an emissivity less than 0.4 and a reflectance larger than 0.6 in mid-IR wavelengths from 7 to 14 μm.

### CROSS-REFERENCE TO RELATED APPLICATIONS

This application claims priority from U.S. Provisional Patent Application 63/355,193 filed Jun. 24, 2022, which is incorporated herein by reference.

### STATEMENT OF FEDERALLY SPONSORED RESEARCH

None.

### FIELD OF THE INVENTION

The present invention relates generally to paints and paint compositions. More specifically, it relates to a bilayer coating for thermal management.

### BACKGROUND OF THE INVENTION

Maintaining enclosed environments with temperature in a predetermined range provides human body thermal comfort and is also crucial for storage and transportation of certain goods. A large amount of energy is consumed every year for maintaining the temperature of thermally-controlled environments, much of which is used to compensate for undesired heat transfer.

One approach to limiting heat transfer is using low-emissivity materials (i.e., materials whose emissivity is at most 0.5) in the mid-infrared wavelength range (i.e., 7 to 14 μm). Existing low-emissivity materials are designed to present high reflectance in both visible and IR wavelengths, and as a result they have a metallized silver or grey appearance. In many practical applications, however, aesthetic appeal provided by bright and vibrant colors are at least as important as the thermal effect provided by materials. Thus, there is a need for low-emissivity materials that are also colorful.

Low-emissivity with a range of visual colors for building wall applications have been developed in the form of thin films. This thin film type of coating, however, imposes limitations on the scope of its applications. The development of colored low-emissivity materials that can be more broadly applied in practical energy saving applications continues to be a significant challenge.

### SUMMARY OF THE INVENTION

Herein is disclosed colorful low-emissivity paints that may be used to form bilayer coatings having an IR-reflective bottom layer and a visibly colorful IR-transparent top layer. The coating achieves mid-infrared (MIR) reflectance of ˜80%, which can efficiently reduce both heat gain and heat loss through thermal radiation. Meanwhile, the colorful visual appearance ensures the aesthetic effect comparable to conventional paints. In addition, its hydrophobicity, environmental durability, and easy cleaning features provide further advantages for practical use. Moreover, its versatility for assorted surfaces of various shapes and materials renders it extensively useful in scenarios including building envelopes, transportation and storage.

Commercial applications include commercial paint products, which can be used on opaque envelopes of various spaces, such as buildings, cargos for cold-chain transportation, storage rooms, etc. The paints can help reduce both heat loss and gain through envelopes not sacrificing aesthetical appearance.

Compared to low-thermal-conductivity insulation materials, such as fiberglass, cellulose, polymeric foam, aerogels, vacuum insulation panels, these colorful low-emissivity paints will add almost no extra volume and weight to the applied envelopes.

Compared to other radiant barrier materials used for opaque envelopes (e.g., metalized/metal foils within walls, using hollow bricks with reflective inner surfaces, and applying paints containing heat reflective materials like silver dust and Aluminum), which are usually only in grey/silver color and restricted to be used where decorative appearance is not a concern, these colorful low-emissivity paints decrease thermal radiation exchange and satisfy aesthetical effect simultaneously.

In one aspect, the invention provides a bilayer coating for thermal management. The coating has a bottom layer composed of aluminum microflakes in a Nitrile Butadiene Rubber-co-Urea (NBR-U) polymer binder. The bottom layer has key properties of low emissivity and high reflectivity in mid-IR. The top layer of the coating is composed of nanoparticle pigments in the NBR-U binder. This top layer has key properties of exhibiting visible color while being IR transparent. The NBR-U binder combines IR transparency with good adhesion.

The invention provides a combination of nanoparticle pigments and aluminum flakes for IR reflectivity in a bilayer coating using an NBR-U binder in both layers. The combination of these features provides a coating with simultaneous advantageous features of visible color, low IR emissivity, and high IR reflectivity.

In one aspect, the invention provides a bilayer coating for thermal management comprising: a bottom layer composed of aluminum microflakes dispersed in a Nitrile Butadiene Rubber-co-Urea (NBR-U) polymer binder, wherein the bottom layer has emissivity less than 0.4 and reflectance larger than 0.6 in mid-IR wavelengths from 7 to 14 μm; and a top layer composed of nanoparticle pigments in the NBR-U polymer binder, wherein the top layer has a transmittance larger than at IR wavelengths.

The aluminum flakes and the NBR-U polymer layer preferably have a mass ratio in the bottom layer in the range from 100:1 to 100:1000, or more preferably in the range from 100:5 to 100:200, or most preferably substantially equal to 10:3.

The nanoparticle pigments and the NBR-U polymer layer preferably have a mass ratio in the top layer in the range from 100:1 to 100:1000, more preferably in the range from 100:10 to 100:200, or most preferably substantially equal to 100:50.

Each of the aluminum microflakes preferably has a lateral size in the range 100 nm to 1 mm and a thickness in the range 10 nm to 10 μm. The bottom layer preferably has a thickness between 5 and 10 μm. The top layer preferably has a thickness in the range 100 nm to 20 μm. The nanoparticle pigments preferably have a mean diameter in the range 10 nm to 10 μm, or more preferably in the range 20 nm to 1 μm.

### BRIEF DESCRIPTION OF THE DRAWINGS

FIGS. 1A, 1B are schematic illustrations of the design principle and exhibition of sample coating, where FIG. 1A shows the working mechanism of the colorful low-emissivity paints, and FIG. 1B is a schematic illustration of the bilayer structure for the coating, according to an embodiment of the invention.

FIGS. 2A, 2B show the chemical structure and ATR-FTIR spectrum, respectively, of Nitrile Butadiene Rubber-co-Urea (NBR-U).

FIG. 3 is a graph of total reflectance in MIR wavelength range of a plain Al microflake coating with varied ratios of Al to polymer binder.

FIG. 4 shows ATR-FTIR spectra of pigment nanoparticles for blue (PB), red (Fe₂O₃), yellow (α-FeOOH) and white (ZnO) colors.

FIGS. 5A, 5B, 5C are SEM images showing, respectively, the surface morphology of the plain Al microflake coating, the surface morphology of the colorful (red) bilayer low-emissivity coating, and a cross-section of the bilayer red low-emissivity coating.

FIGS. 5D, 5E, 5F are graphs of total reflectance vs wavelength, where FIG. 5D shows a graph for single layer of Al microflake coating and bilayer low-emissivity coatings (BLCs), FIG. 5E shows a graph for single layer of Al microflake coating and bilayer low-emissivity coatings, and FIG. 5F shows a graph for the colorful bilayer low-emissivity coatings on different substrates.

FIGS. 6A, 6B show graphs of total reflectance spectra for the blue, red and yellow bilayer low-emissivity coatings in dark shade in, respectively, MIR and visible-NIR wavelength ranges.

FIGS. 7A, 7B show graphs of total reflectance spectra for the colorful bilayer low-emissivity coatings in orange, purple, green and dark grey in, respectively, MIR and visible-NIR wavelength ranges.

FIG. 8 is a bar graph showing required power density of heaters comparing heat loss through surfaces with different coatings.

FIG. 9 is a graph of temperature increase curves for the truck models with different surface coatings.

FIG. 10 is a bar graph illustrating average measured temperature comparing different coatings in different testing scenarios.

### DETAILED DESCRIPTION OF THE INVENTION

Herein is disclosed colorful low-emissivity paints serving as conventional paints alternative. These paints can be used to create bilayer coatings that combine low-emissivity and colorful appearance. The paints not only satisfy basic functions of conventional paints, but also decrease thermal radiation exchange to save heating or cooling energy.

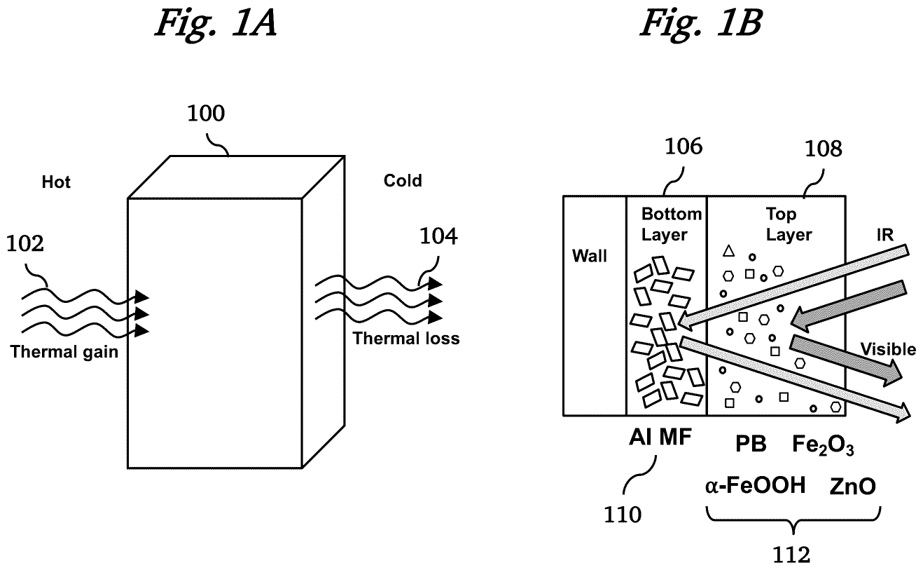

FIG. 1A illustrates the colorful low-emissivity paints resisting thermal radiation exchange with hot environment to reduce heat gain and with cold environment to decrease heat loss. This category of paints is not only suitable for thermal envelopes of buildings as depicted, but applicable to other objects as well. As illustrated in FIG. 1A, these paints are designed to create coatings on envelope surfaces of a building 100 such as walls and roofs to help prevent thermal radiation exchange with surroundings located in mid-infrared (MIR) wavelength range (mainly 7 to 14 μm). In hot weather, the coating decreases the thermal radiation 102 throughput from the hot ambient and from the solar near-infrared (NIR) radiation to reduce heat gain. In cold weather, the coating impedes MIR radiative heat loss 104 from the indoor environment to the outdoor surroundings. Meanwhile, colorful appearance is realized as well by selectively reflecting visible light of the desired color. In other words, the formed coating is targeted at enhancing radiation heat transfer resistance to benefit space cooling and heating energy efficiency without sacrificing visual appearance provided by conventional paints.

As shown in FIG. 1B, embodiments of the invention provide a bilayer coating structure with an IR-reflective layer 106 as the bottom layer, which has high IR reflectance thus resisting heat gain and loss by significantly reducing MIR thermal radiation absorption and emission. Also, it decreases NIR heat gain from the sun. The coating also includes an IR-transparent color layer 108 as a top layer, which selectively reflects desired visible colors but allows high transmission of IR radiation to retain the high IR reflectance of the bottom layer. The top layer creates desired visual appearance using nanoparticle pigments.

The bilayer coating can be produced by successive application of two distinct paints. The bottom layer 106 is formed by application of an IR reflective paint containing aluminum (Al) microflakes (MF) 110. The top layer 108 is formed by application of an IR-transparent colorful paint based on inorganic nanoparticle pigments 112 formulated in assorted colors. Prussian blue (PB), iron oxide (Fe₂O₃), goethite (α-FeOOH) and zinc oxide (ZnO) are preferably used as the nanoparticle pigments to generate primary colors (blue, red, yellow and white, respectively). A variety of colors can be created through appropriate mixing ratios of these primary color pigments. These two paints can be used in place of a conventional paint, providing similar aesthetical effect while additionally providing extra heat insulation effect.

Micro-sized Al flakes 110 are used as the functional component of the heat reflective paint for the bottom layer 106. In the paint, the Al microflakes 110 are dispersed in a binary solvent system (p-Xylene and methylene chloride) with dissolved Nitrile Butadiene Rubber-co-Urea (NBR-U) as the polymer binder.

Discussion on Al Microflake Coating

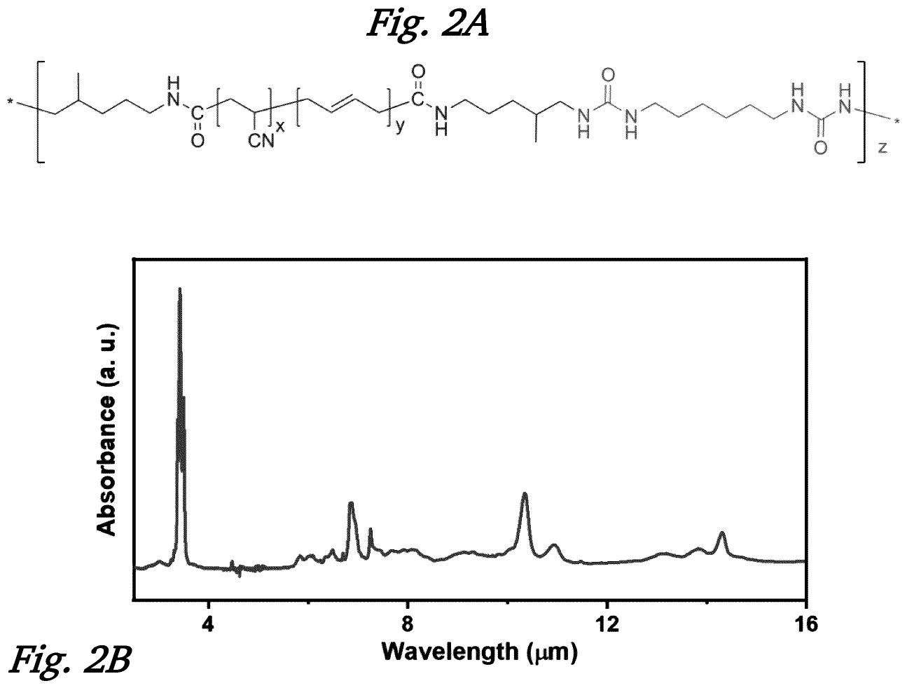

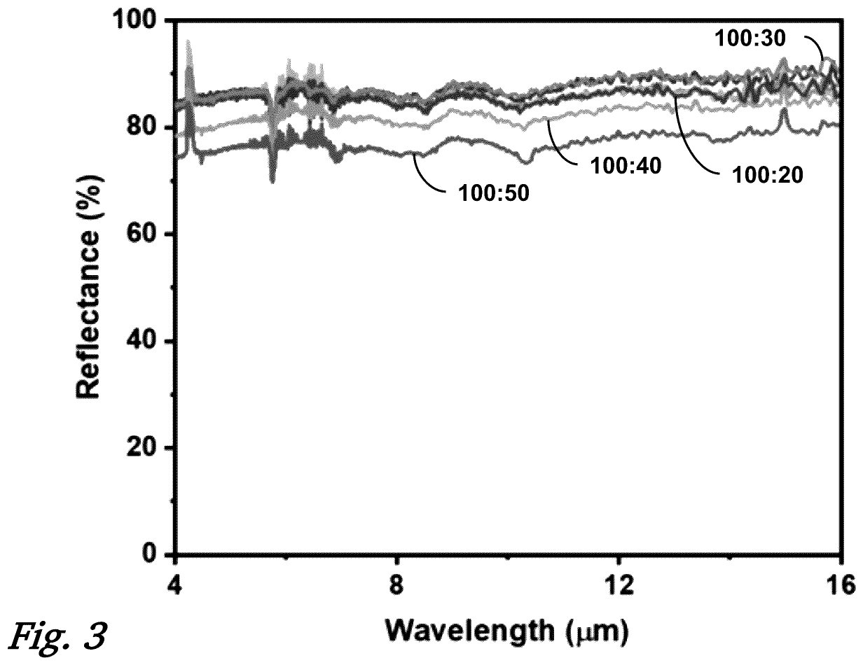

It is important to achieve high MIR reflectance for the Al microflake coating, which serves as the bottom layer in our bilayer structure design. It determines the upper limit of the MIR reflectance for the bilayer colorful low-emissivity coatings. Some optimization of the Al microflake paint formulation is discussed here.
Al particle type: We choose micro-sized Al flakes (dozens of micrometers in diameter) with large aspect ratio in our recipe, in order to obtain denser and flatter surface morphology for the formed coating. In contrast, granular Al particles in the similar size would result in significant reduction in IR reflection due to the “light trap” effect caused by rough surface morphology and multiple scattering among the loosely packed particles.
Solvent selection: Considering the surfactant modified surface of Al microflakes, we chose to use a non-polar solvent, p-Xylene (polarity=0.074, assuming water=1) (ref. 1), to sufficiently disperse the Al microflakes. Its slow evaporation rate (0.6, assuming Butyl Acetate=1) helps the oriented assembly of Al microflakes. In our preferred recipe, a binary solvent system (p-xylene-methylene chloride) was adopted due to the demand of dissolving the polymer binder. During the film-forming process, methylene chloride evaporates much faster (evaporation rate=14.5) than p-Xylene, therefore it seldom affects the assembly of Al microflakes in the p-Xylene.
Polymer binder: We select polymer binder for our formulation in the principle of providing good adhesion meanwhile showing fair MIR transparency. The adopted polymer binder (NBR-U) shows decent adhesion for both heat reflective layer and color layer because abundant hydrogen bonds can form between the polymer (e.g. urea and nitrile groups) and the particle surface (e.g. hydroxyl, carboxyl, cyano groups). Meanwhile, NBR-U does not strongly absorb MIR radiation because it has an alkyl/vinyl backbone. FIG. 2A shows the chemical structure of Nitrile Butadiene Rubber-co-Urea (NBR-U) and FIG. 2B shows its ATR-FTIR spectrum.
Ratio: The measured MIR total reflectance for varied mass ratios between plain Al microflakes and polymer binder is exhibited in FIG. 3. We selected the 100:30 ratio of Al:NBR-U as the optimized one in the principle of achieving both high MIR reflectance and decent adhesion. The same principle was also applied when choosing the mass ratio between pigment and polymer binder for the IR-transparent colorful paints.

Returning to FIG. 1B, we select inorganic IR-transparent nanoparticles as pigments 112 to formulate the colorful IR-transparent paints for the top layer 108.

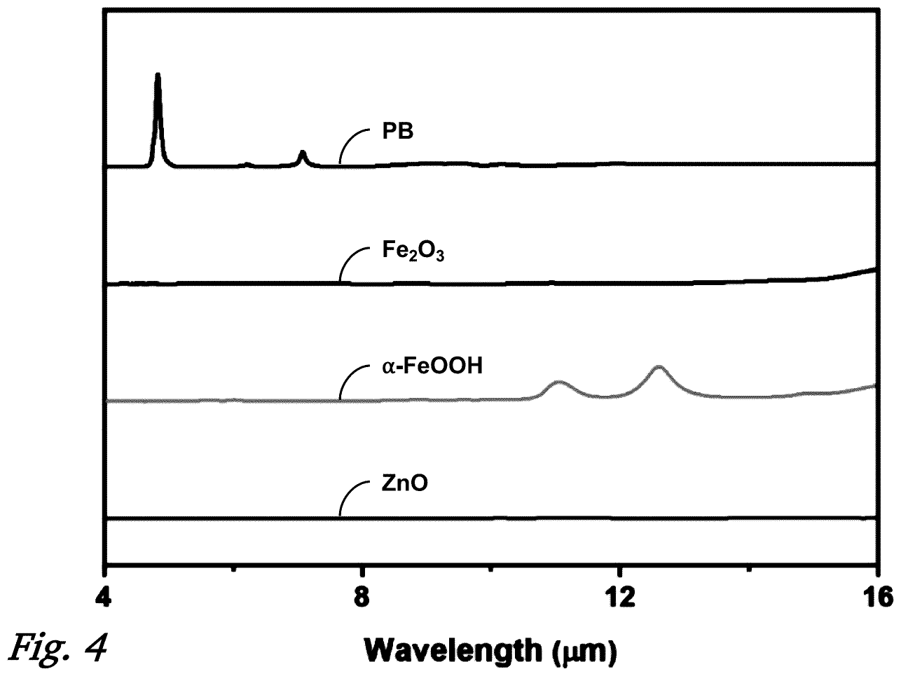

FIG. 4 shows attenuated total reflection-Fourier transform infrared (ATR-FTIR) spectra of pigment nanoparticles for blue (PB), red (Fe₂O₃), yellow (α-FeOOH) and white (ZnO) colors. These spectra show that these inorganic solids have negligible absorbance in the MIR wavelength range, except for an intense and narrow peak of PB at 4.8 μm due to —C≡N stretching vibration and two weak and broad peaks of α-FeOOH due to —OH bending vibration. Their particle sizes are preferably in the range of 20-1000 nm, which is far smaller than the MIR radiation wavelengths thus strong scattering can be greatly avoided for high IR transparency. In the paint formulation, one or multiple types of inorganic IR-transparent nanoparticle pigments are dispersed in NBR-U (binder)-acetone (solvent) system. By spray coating, the nanoparticles are dispersed on the top surface of oriented Al microflakes.

Optical Characterization

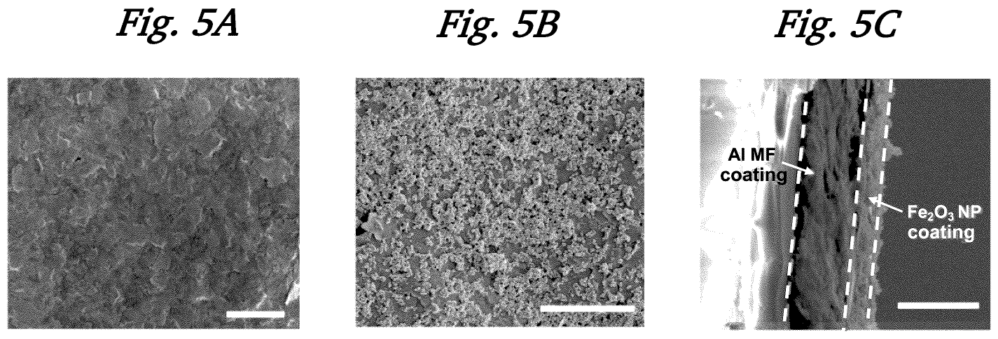

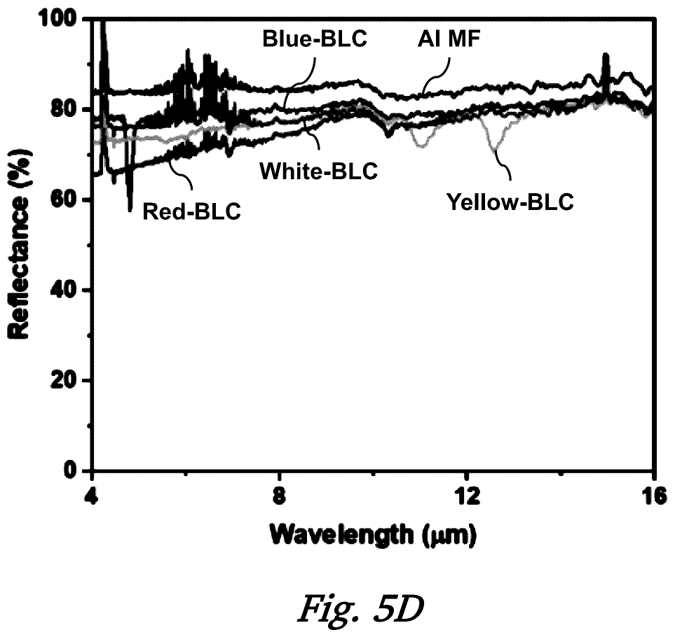

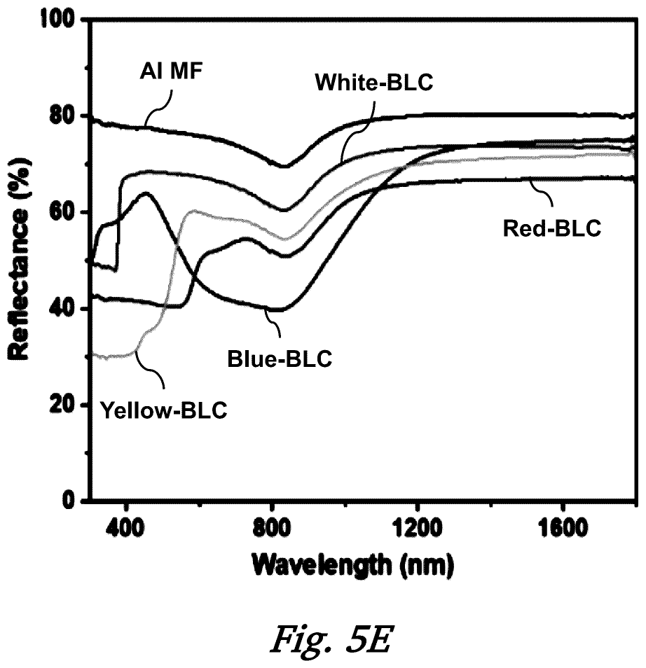

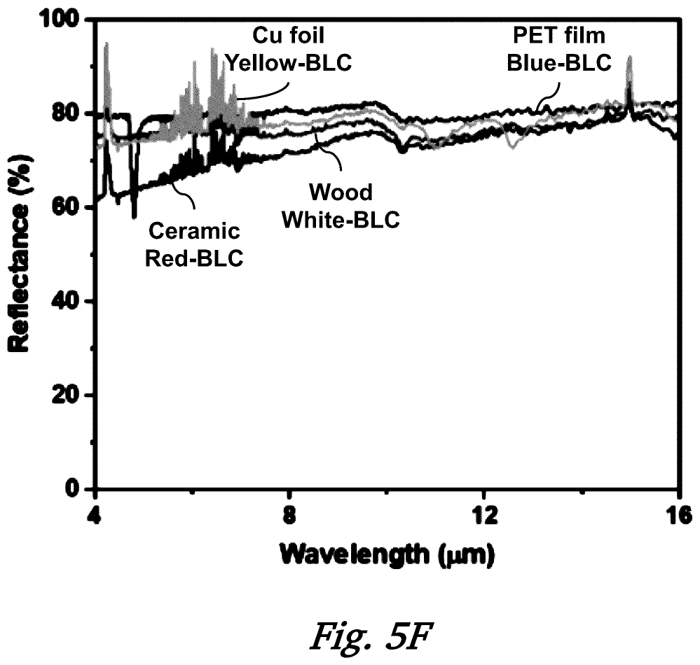

As seen in the scanning electron microscope (SEM) image of the plain Al microflake coating surface morphology of FIG. 5A, the Al microflakes with large aspect ratio and surfactant modified surface tend to congregate and orientate to assemble a dense and smooth surface. FIG. 5B is an SEM image of the colorful bilayer low-emissivity coating, of which bottom is Al microflake coating and top is Fe₂O₃ nanoparticle (NP) coating. A typical bilayer colored (red) low-emissivity coating is displayed in FIG. 5C, an SEM image of the cross-section of the bilayer red low-emissivity coating. The dash lines locate the Al microflake coating while red dash lines locate the layer of Fe₂O₃ NP coating. A combination of Al microflake layer in approximately 5-10 μm thickness and color layer in a few micrometers thickness is sufficiently lead to apparent colors and fairly high MIR reflectance. We denote the bilayer low-emissivity coatings in different colors as “color”-BLC, such as blue-BLC.

FIG. 5D shows measured total reflectance in MIR wavelength range on glass substrate for single layer of Al microflake coating and bilayer low-emissivity coatings (BLCs) in blue, red, yellow and white. Such an Al microflake coating shows MIR reflectance of ˜85%, equivalent to ˜0.15 emissivity, which is a comprehensive outcome of selection of Al particle type, solvent and polymer binder, and their ratio optimization. Glass that is highly IR emissive and visible transparent was adopted as the substrate. The addition of top color layer reduces the total MIR reflectance due to the inevitable thermal absorption by the polymer binder and porous morphology, but the total MIR reflectance can still reach up to ˜80%. In contrast, conventional paints in the same colors show reflectance lower than 10% in the MIR wavelength range, which strongly absorb thermal radiation. We also measured the total reflectance of these colored low-emissivity coatings in the visible and NIR wavelength ranges with a UV-Vis-NIR spectrometer equipped with a diffuse reflectance accessory. FIG. 5E shows measured total reflectance in visible and NIR wavelength range on glass substrate for single layer of Al microflake coating and bilayer low-emissivity coatings in blue, red, yellow and white. The single layer of plain Al microflake coating exhibits ˜80% reflectance across the whole visible and NIR wavelength range; The spectra of bilayer coatings in primary colors show 65%-75% reflectance in NIR wavelength range while revealing different dominant reflection visible wavelengths for blue, red and yellow colors. Conventional paints also show selective reflectance peaks corresponding to their colors, whereas their reflectance in both visible and NIR wavelengths is overall much lower.

It is worthwhile to point out that changing the loading mass of the colorful coating can result in varied shades for different colors. Even though some spectra variation is observed, fairly high IR reflectance can be retained even for very dark shades.

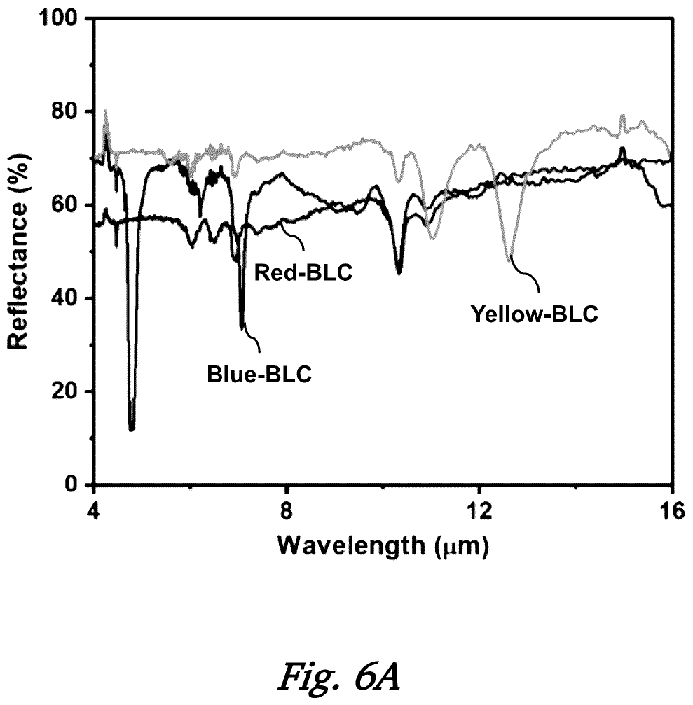

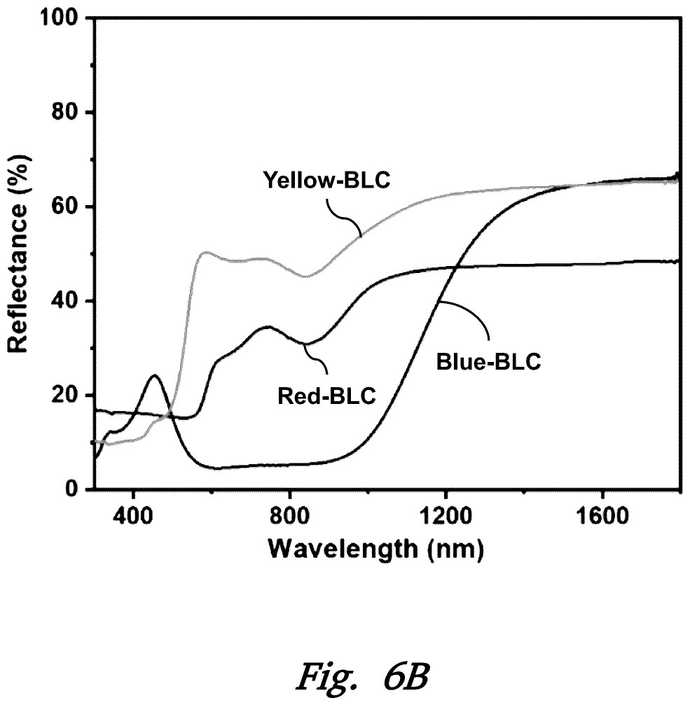

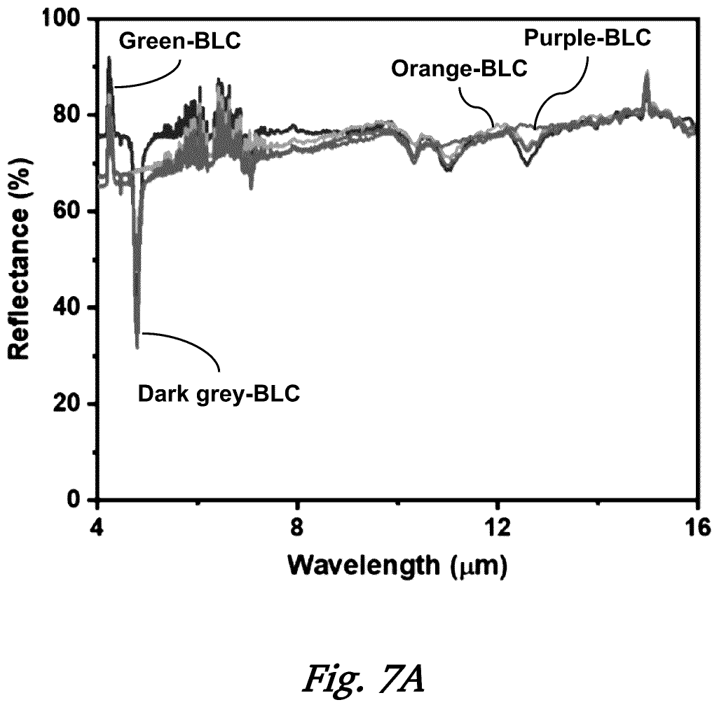

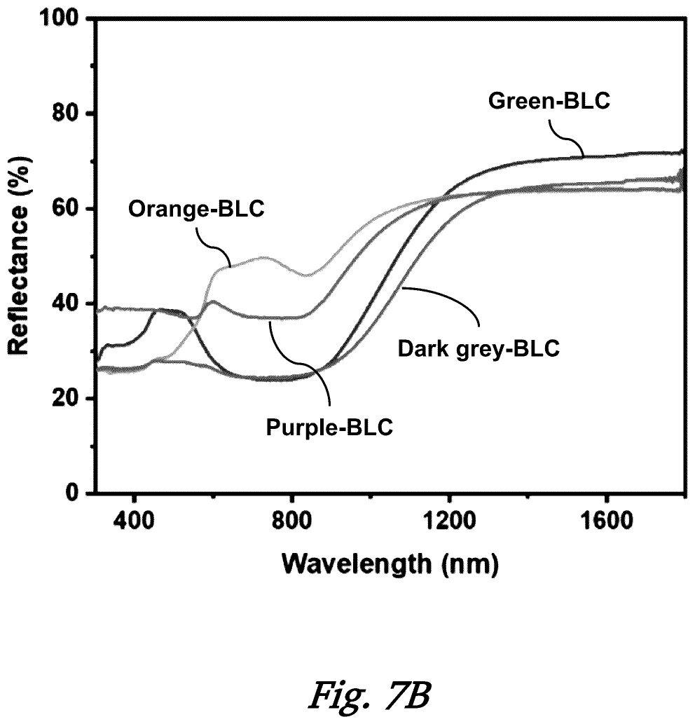

FIG. 6A is a graph of measured total reflectance spectra in MIR wavelengths. FIG. 6B is a graph of measured total reflectance spectra in visible-NIR wavelength ranges. These graphs show the reflectance spectra for the blue, red and yellow bilayer low-emissivity coatings in dark shade. The measured spectra of bilayer coatings in colors generated by mixing pigments for primary colors are displayed in FIG. 7A, 7B, which show measured total reflectance spectra in MIR and visible-NIR wavelength ranges, respectively, for the colorful bilayer low-emissivity coatings in orange, purple, green and dark grey.

We also examined the thermal radiation reflection performance of the formulated colorful low-emissivity paints on different substrates (plastics, wood, ceramics, metal, glass). The MIR reflectance of the plain Al microflake coating on different materials were measured, observing almost identical MIR reflectance on all the tested materials. This is because the Al microflake paint for bottom-layer coating can well match different substrates and alter their surface morphology to be similar to congregated and oriented Al microflake assembly. As a result, the MIR reflectance for colorful bilayer low-emissivity coatings on varied substrates exhibits similar spectra to those on the glass substrate, as displayed in FIG. 5F, which shows measured total reflectance in MIR wavelength range for the colorful bilayer low-emissivity coatings on different substrates.

Heat Insulation Effect Demonstration

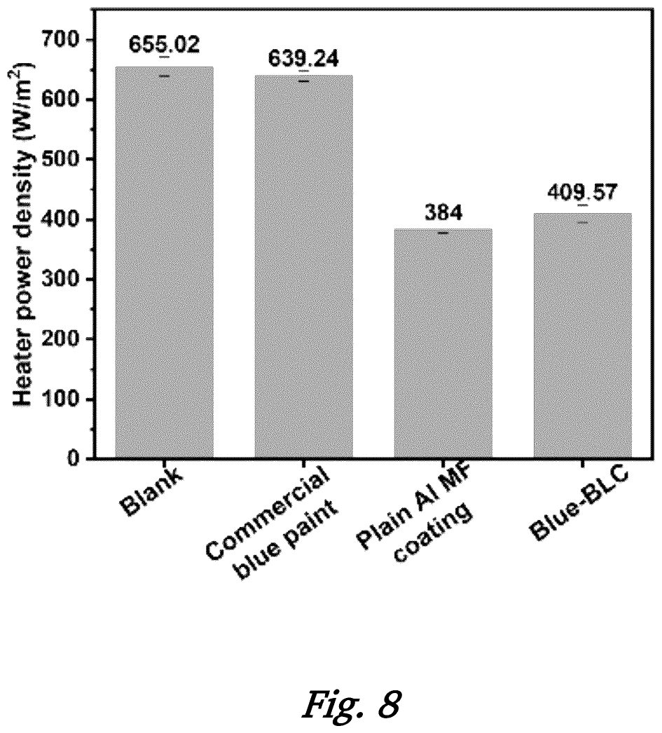

The thermal performance and heat insulation effect of the coatings was investigated. Building simulants were built with an inserted electric heater that can generate heat, outer surfaces of which were unmodified, with single layer of plain Al microflake coating, with blue-BLC, and with commercial blue paint coating, respectively. We measured the required power density of the heater to resist heat loss and maintain the same inside temperature of the building simulants at constantly 25° C. (measured by inserted thermocouples in the building simulants) in a cold environment (5° C.). The positions of heaters and thermocouples were both identical in every building simulant for different coating samples, for parallel comparison. The plain Al microflake coating and blue-BLC can both significantly reduce the heater power density in demand, compared to the blank building simulant and commercial blue paint, which validates the reduction of heat exchange with the ambient environment and great potential of building energy saving. FIG. 8 compares measured required power density of heaters with different paint coatings. The plain Al microflake coating and blue-BLC both significantly decreased the required power density by reducing indoor heat loss.

Owing to the installation flexibility and versatility, our colorful low-emissivity paints are suitable to be used in other scenarios that require thermal regulation. For example, they can be used on cargo trucks for cold-chain transportation, preserving inside goods with less cooling energy consumption meanwhile providing vast flexibility of truck's appearance design. Besides, the cargo trucks will be burdened with almost no extra weight and volume. We prepared three cargo truck models with painted cargo boxes (three faces) by commercial white paint, Al microflake paint and white-BLC, respectively. They were tested in an artificial hot environment (40° C.).

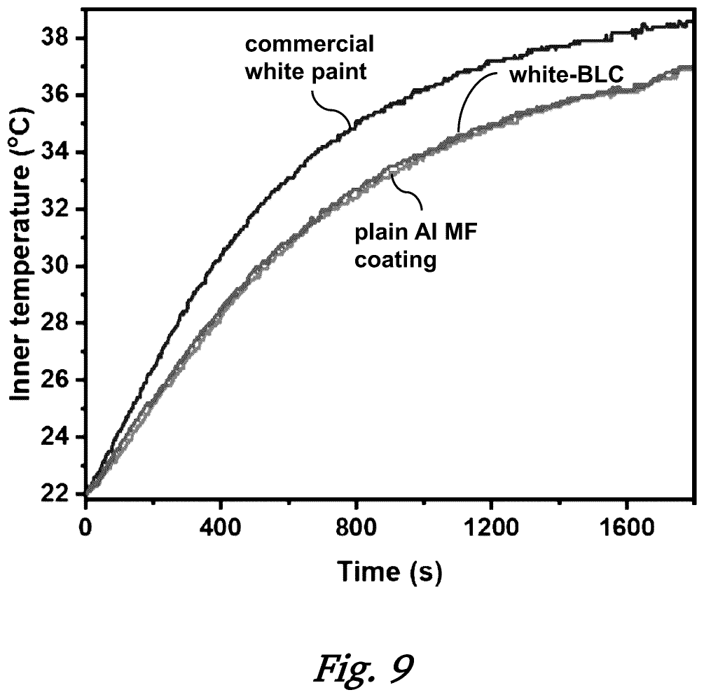

The white-BLC was expected to afford similar heat insulation effect to the Al microflake paint, whereas it can ensure the same aesthetical effect as the commercial white paint. To demonstrate their heat resistance performance, we first measured the increase of inside temperature once the samples were put into the hot environment. The plain Al microflake paint and white-BLC both led to much slower inner temperature increase in contrast to the commercial white paint, as exhibited in FIG. 9, which shows measured temperature increase curves for the truck models with different surface coatings. The plain Al microflake coating and white-BLC can greatly decrease the temperature increase by resisting radiative heat gain from the ambient. This well verifies the high thermal reflectance of these paints can effectively alleviate radiative heat gain from the ambient. Plus, we performed tests to characterize the mass change of phase change materials that are usually utilized during cold-chain transportation. Ice cubes were chosen as a representative of phase change material and were stored inside the cargo boxes in the same hot ambient environment. It was observed that both plain Al microflake coating and white-BLC can significantly slow down the ice melting speed by around 20.8%. At the end of test, the mass of ice cubes inside cargo boxes with low-emissivity coatings were approximately twice as much as the one with commercial white paint. It indicates a great amount of cooling energy or phase change materials for temperature maintenance can be saved during transportation.

The experiments conducted in artificial hot/cold environments effectively demonstrate the heat insulation properties of our materials. To further evaluate their cooling performance during hot days, we carried out outdoor tests under real summer weather conditions, where solar radiation and sky access were involved. We compared commercial paints with a thickness of ˜10 μm (the same as BLCs) to BLCs. In our tests, BLCs resulted in lower temperatures because their high near-infrared (NIR) reflectance, which reduces solar heat gain, outweighs the limited mid-infrared (MIR) radiation to the sky.

Building HVAC Saving Simulation

In addition, we utilized a commercialized building energy simulation software—EnergyPlus (version 9.5), to calculate how much HVAC energy can be saved annually for a typical midrise apartment building if the colorful low-emissivity paints are applied to walls and roofs. We examined cities in different climate zones across the United States, and hourly weather data in every location for a typical meteorological year (TMY3) was utilized as external weather condition, comprehensively involving temperature, relative humidity, wind direction and speed, solar radiation, etc. The HVAC saving consists of heating energy saving, cooling energy saving and fans energy saving. The decoupled energy saving maps for heating, cooling and fans show that universal heating energy saving can be realized by installation of our colorful low-emissivity paints, because it can help reduce heat loss for indoor environments during cold days. The annual heating energy saving value varies from 0.32 GJ (Kona, Hawaii) to 66.05 GJ (Winslow, Arizona), which is influenced not only by local weather but also by the building's insulation condition. In general, the heating energy-saving effect is more pronounced for cold climate zones and buildings with less insulation. In our simulation, the maximum heating energy savings were not observed in the coldest climate zone (Alaska), which could be attributed to the fact that the original building insulation in this area is already the best. For cooling energy savings, it indicates that the application of our paints exhibits a more significant effect on less-insulated buildings in hot climate zones. For instance, the annual cooling energy saving for Miami amounts to 35.64 GJ. It is also due to the reduced solar heating that offsets the limited radiative cooling to the sky. On the other hand, installing our colorful low-emissivity paints causes negative cooling energy savings in some cities, where the decreased sky radiative cooling by low MIR emissivity dominates. The negative effect on cooling energy saving might be relieved for buildings in urban areas, in which the view factor to sky is much smaller than that of an isolated building simulated here. Fans are responsible for circulating air throughout the building, commonly used in conjunction with cooling and heating systems helping to distribute the cooled and heated air throughout the building. The installation of our low-emissivity paints can result in fans energy saving up to 12.22 GJ, which is also more pronounced in hot climate zones. Overall, positive total HVAC energy savings can be achieved across the U.S. by installation of our materials. Up to 85.4 GJ energy can be saved annually (corresponding to 7.4% saving ratio), and the energy saving effect is universal across the whole country, revealing a huge amount of electricity and natural gas can be saved and leading to greenhouse gas emission reduction.

Materials Synthesis and Fabrication.

The Al microflakes used for paint formulation was used as purchased (Fisher Scientific, 99.7%). All the solvents were purchased from Fisher Scientific without further purification. Nitrile Butadiene Rubber-co-Urea (NBR-U) polymer binder was synthesized via the one-pot reaction between the primary amine-terminated Nitrile Butadiene Rubber (NBR, Hypro 1300×42, Huntsman, with 18% Acrylonitrile) and Hexamethylene Diisocyanate (HDI, Sigma-Aldrich, 99%) in methylene chloride at 25° C. for 24 h. The as-prepared polymer Nitrile Butadiene Rubber-co-Urea (NBR-U) was dissolved in methylene chloride and purified by washing with large amount of methanol. The final polymer NBR-U was obtained by removing the solvent under vacuum (FIG. 2A, 2B, yield 89%). The polymer NBR-U was dissolved and stored in methylene chloride with the concentration of 50 mg/mL before use. The complete Al microflake paint formulation was made by mixing the Al microflakes, NBR-U solution and p-Xylene solvent, with the ratio of Al mass (g):NBR-U mass (g):solvent volume (methylene chloride and p-Xylene, mL) equal to 10:3:110. The mixture was stirred and sonicated for better dispersion. The pigment nanoparticles include PB (ACROS Organics), iron oxide (Sigma-Aldrich, 99%), goethite (Sigma-Aldrich, 30-63% Fe), ZnO (Sigma-Aldrich, 99.9%) were used as purchased. The color paints were made by mixing the pigment nanoparticles, NBR-U solution and acetone solvent with the ratio of pigment mass (g):NBR-U mass (g):solvent volume (methylene chloride and acetone, mL)=1:0.5:110). Similarly, the mixture was stirred and sonicated for better dispersion. White, blue, red and yellow colors were realized by a single kind of pigments, while other colors were made by mixing two or three kinds of pigment nanoparticles at a certain ratio. When preparing coatings, the solutions were loaded into a spray gun (3M) and sprayed onto substrates at room temperature. The loading mass density per unit area was calculated by weighing sample mass before and after spraying coatings, and the substrate area. Commercial paints were purchased from Home Depot (blue: Glidden Premium, red: BEHR Marquee, yellow: BEHR Premium plus, white: Glidden Premium). They were diluted by acetone and applied on substrates by the same spray coating method. The loading mass density per unit area can be calculated by the same method as above.

Material Characterization.

The MIR reflectance was measured by a FTIR spectrometer (Model 6700, Thermo Scientific) accompanied with a diffuse gold integrating sphere (PIKE Technologies). ATR-FTIR spectra were measured by Nicolet i550 FTIR Spectrometer. The visible and NIR reflectance was measured by UV-Vis-NIR spectrometers (Agilent, Cary 6000i and Jasco V-670) equipped with diffuse reflectance accessories. SEM images were taken by FEI Nova NanoSEM (5 kV). The contact angle was measured by contact angle goniometer (Rame-Hart 290). The sample mass was measured by an analytical balance (Ohaus Pioneer, 0.0001 g readability).

Environmental Durability Tests.

1) High temperature test: the sample was put into an oven (MTI, SS-00AB table dry oven) at a constant temperature of 80° C. and maintained for one week; 2) Low temperature test: the sample was put in a Dewar filled with liquid nitrogen for one week. The tested sample was soaked in liquid nitrogen during the whole testing process; 3) Acid test: concentrated sulfuric acid (95-98%, Sigma-Aldrich) was diluted with deionized water. Its pH was adjusted to be around pH=4 (tested by pH test strips, EMD Millipore). The sample was immersed in the solution continuously for one week; 4) Alkali test: potassium hydroxide solution (pH=10, tested by pH test strips, EMD Millipore) was prepared by potassium hydroxide (Sigma-Aldrich) and deionized water. The sample was immersed in the solution continuously for one week. The MIR spectra of samples were measured and photographs were taken before and after tests.

Color Fastness Test.

The test method was modified from ASTM D7377. The sample was fixed with a tilt angle of ˜45° at the distance of 5 cm from the water faucet. The flow rate of water from the faucet was ˜300 mL/min. Water hit on the sample and then flew into the sink. Sample mass was measured at time intervals.

Heat Insulation Performance Demonstration in Artificial Cold/Hot Environments.

1) Artificial cold environment test. The building simulants with 5 cm side length were assembled by clear acrylic boards (1.5 mm thick, McMaster-Carr). Their bottom faces were insulation foams. Polyimide insulated flexible heaters (McMaster-Carr, ˜25 cm 2) connected to a power supply (Keithley 2400) were fixed in the building simulants to provide heating power. Small holes (1 mm in diameter) were cut by a CO₂ laser cutter (Epilog Fusion M2) for inserting thermocouples (K type, Omega Engineering) into the building simulants. A data logger (HH374, Omega Engineering) was used to record the temperature data of the building simulants. The air temperature in the enclosed chamber (artificial cold environment) was measured by a thermocouple (K type, Omega Engineering) as well, and it was controlled at 5° C. by a circulated water system. The supplied power density was adjusted for different surface coatings to make the inside temperature of the building simulants stable at 25° C.

2) Artificial hot environment test. The cargo truck models were purchased from Amazon. The dimension of cargo box is 23.5 cm×4.5 cm×3.6 cm. We added different coatings to the cargo box outer surfaces (three faces). Similarly, thermocouples (K type, Omega Engineering) were put into the cargo boxes, and they were connected to a data logger (HH374, Omega Engineering). The air temperature in the enclosed chamber (artificial hot environment) was measured by a thermocouple (K type, Omega Engineering) as well, and it was controlled at 40° C. by a circulated water system. The temperature increase curves were recorded once the truck models were put into the enclosed chamber. For the ice test, ice cubes of nearly the same mass and shape were put in a top-open acrylic container with bottom heat insulated, and the acrylic container was transferred into the cargo boxes. At certain time intervals, the ice container was taken out for photographs and ice mass was measured by taking out and absorbing surface liquid water rapidly. For the building simulants and cargo truck models with different surface coatings, we fixed their position in the artificial hot/cold environments, as well as the position of thermocouples, heaters and ice cube containers, to make the measurements as parallel as possible to provide reasonable comparison.

Energy Saving Calculation by EnergyPlus.

EnergyPlus (version 9.5) was used to perform whole building energy simulation. We used commercial reference building model (post-1980 midrise apartment) defined by U.S. DOE. The model building has four stories, including 31 apartments plus an office. The building shape is rectangular with an aspect ratio of 2.74 (Length: 46.33 m, width: 16.91 m, Height: 12.19 m). Building North axis is 0 degree to true North. The total floor area is 3135 m². The windows cover 15% of the total wall surface area. The building is isolated (i.e., no neighboring buildings/objects). Internal gains and HVAC system have been comprehensively designed in the models. For the HVAC systems in the building, DX cooling is employed for cooling (COP=3.13), while gas furnaces (burner efficiency=0.8) and electric heaters (efficiency=1) are used for heating. The fan's efficiency is 0.536. The indoor air temperature set-point was set constantly as 22° C., and the external weather utilized hourly weather data for a typical meteorological year (TMY3) of different cities. The weather data comprehensively includes temperature, relative humidity, wind direction and speed, solar radiation, etc. The wall and roof insulation condition of the modeled building is defined in the downloaded EnergyPlus models for 16 cities (Miami, Houston, Phoenix, Atlanta, Los Angeles, Las Vegas, San Francisco, Baltimore, Albuquerque, Seattle, Chicago, Boulder, Minneapolis, Helena, Duluth and Fairbanks). The insulation condition varies in different locations. The building insulation conditions in other cities are extrapolated from the above 16 cities. The baseline HVAC energy use, including cooling, heating and fans, was calculated for the building model with conventional wall and roof properties (as set in the downloaded EnergyPlus models). The initial solar reflectivity values of the building exterior wall, interior wall and roof are 0.22, 0.08 and 0.3, respectively, and MIR emissivity (thermal absorbance) values are all 0.9. To calculate the HVAC energy use with installation of our colorful low-emissivity paints, we modified optical properties of the wall and roof surfaces (both inside and outside sides) in the building model, using experimental measured data (solar reflectivity: 0.55, MIR emissivity: 0.23, average value of low-emissivity paints in blue, red, yellow and white). Comparing the energy use difference between building models with and without colorful low-emissivity paint installation, we obtained the all-year energy saving for cooling, heating, fans and total HVAC. In total, we tested 129 cities across the U.S. using EnergyPlus. The energy saving map was plotted on the basis of EnergyPlus calculations for 129 cities across the U.S. and extrapolating to neighboring counties.

Outdoor Tests.

All the tests were performed on a flat building roof in Stanford, CA, in May 2022. For the coating samples on flat film substrates, acrylic boxes (dimension: 21 cm×21 cm×6.5 cm) were made, with open windows (5 cm×5 cm) on the top side. All the surfaces of the boxes were covered with Mylar foil. Styrofoam (thickness: 5.1 cm) was fixed on the bottom of acrylic boxes. Aerogel blanket (dimension: 10 cm×10 cm×0.8 mm) sit on the styrofoam. All the exposed surfaces of the foam and aerogel blanket were covered with Mylar foil. The substrates for coating samples were modified polyester films (5 cm×5 cm×300 μm), with black color and solar absorbance of ˜0.8. We set the solar absorbance at this value according to the exterior wall material parameter in commercial reference building model (post-1980 midrise apartment) defined by US DOE in EnergyPlus version 9.5. Sample coatings were applied to the substrates by controlling the same thickness (˜10 μm). Samples were mounted above the aerogel blanket with a gap of ˜2 mm, facing the open windows of the boxes. Thermocouples (K type, Omega Engineering) were attached to the bottom side of sample substrates and connected to a data logger (HH374, Omega Engineering). Infrared transparent low-density polyethylene films covered the open windows right above samples during tests. In testing Scenario 1, the testing boxes were put on a horizontal platform (distance to the ground, ˜0.75 m). In testing Scenario 2 and 3, the testing boxes were fixed in the vertical direction to the ground (distance to the ground, ˜0.5 m). Air and ground temperature was recorded by thermocouples (K type, Omega Engineering) exposed in air and fixed into the roof ground surface (crushed stones). For tests of cargo truck models, the cargo boxes were modified to be solar opaque (solar absorbance ˜0.8) as well, and then coatings were applied onto three faces of the cargo boxes. Thermocouples (K type, Omega Engineering) were inserted into the cargo boxes and fixed at the center of boxes. The truck models were placed on styrofoam wrapped with Mylar foil, sitting on heat insulation platform (styrofoam, thickness: ˜10 cm) with solar opauqe surface. The truck models were totally exposed to air without any convection shield during the tests. A thermocouple was attached onto the surface to record ground temperature and another thermocouple in air was used to measure air temperature. Thermocouples were connected to a data logger (TC-8, Omega Engineering). Solar irradiance was measured using a pyranometer (Kipp & Zonen CMP6) and a data logger rated to a directional error of ±20 W/m² was used to record data. The pyranometer was placed on the roof ground.

Outdoor Cooling Performance

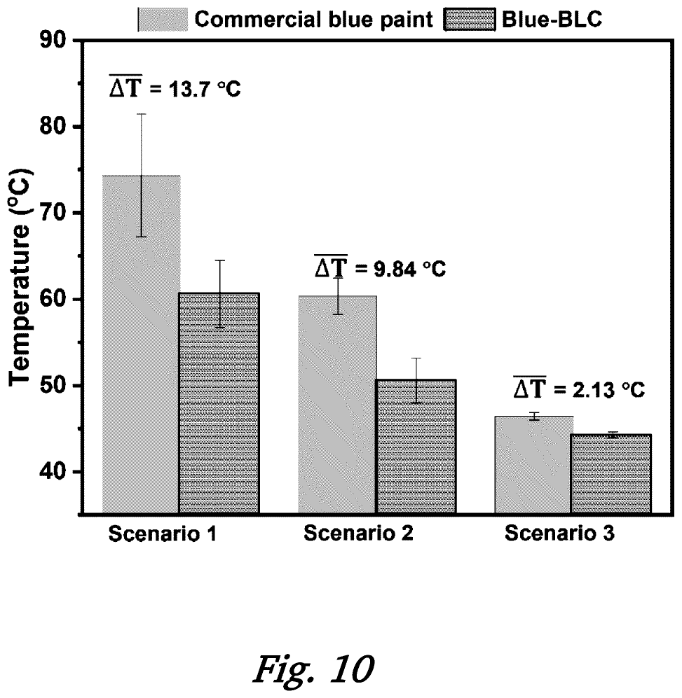

We conducted the experiments in three testing scenarios: 1) horizontal samples, facing sky, with direct beam sunlight; 2) vertical samples, with direct beam sunlight; 3) vertical samples, without direct beam sunlight. FIG. 10 is a bar graph comparing blue-BLC sample exhibited evidently lower temperature than the commercial blue paint by measuring average measured temperature in different testing scenarios. The error bars show standard deviation. AT refers to the average temperature difference between commercial blue paint and blue-BLC. As shown in FIG. 10, the blue-BLC sample exhibited evidently lower temperature than the commercial blue paint sample, in all the testing scenarios. In scenario 1, despite the low emissivity in MIR wavelengths that resulted in less heat emission to the cold sky, the high NIR reflectance tremendously decreased solar heat gain for the blue-BLC. Thus, cooling effect of 13.7° C. was observed. In scenario 2, blue-BLC could still resist more solar heating than the commercial blue paint, meanwhile reducing more heat gain from the hot ground, which led to 9.84° C. lower average temperature. In scenario 3, the avoidance of direct beam sunlight made temperature of both samples decrease apparently, whereas the blue-BLC sample still exhibited 2.13° C. lower temperature, as the result of reflecting more diffuse solar radiation and ground heat radiation.

Furthermore, we compared the blue-BLC and commercial white paint of the same thickness (˜10 μm), using testing scenario 1 in which the sky access was maximized for the high-emissivity commercial paint. The measurement result of a 6.7° C. cooling effect for the blue-BLC sample reveals our colored BLC can even be cooler than conventional white paint in hot days. This is still the result of high solar reflectance that outweighs low MIR emissivity.

The cargo truck models with white-BLC and commercial white paint (covered three faces of the cargo boxes) were also tested under outdoor condition. A heat insulative platform was built, and its surface was modified to be solar absorbing to mimic common outdoor ground condition. The cargo truck models sit on two heat insulation stages wrapped with Mylar foil, to avoid excessive heat conduction from the ground. Thermocouples were inserted into the cargo box center for temperature measurement. The whole set-up was totally exposed to the environment. The inside temperature of cargo box with white-BLC was around 3.9° C. lower than that of commercial white paint one.

In the above tests, ˜10 μm thickness for commercial paints was adopted to match the thickness of BLCs, whereas this is not the suggested typical thickness of commercial paints for usage. According to their technical data sheets, their typical thickness is about 40 μm. To study commercial paints in/over the typical thickness range, we performed measurements in solar wavelengths for commercial paints (blue, red, yellow, white) of ˜40 μm, 80 μm and 120 μm.

Increasing the thickness of commercial paints can enhance their reflectance in solar wavelengths. For commercial blue and red paints, even with a thickness of 120 μm, they still exhibit lower reflectance compared to their respective BLCs. For commercial yellow paint, a 40 μm sample has a lower solar reflectance (40.06%, weighted average value based on solar irradiance spectrum) than Yellow-BLC (54.06%). However, an 80 μm sample demonstrates a comparable value (53.06%), and a 120 μm sample presents a higher solar reflectance (60.41%) than Yellow-BLC. For commercial white paint, a 40 μm sample already achieves 78.54% solar reflectance, surpassing that of White-BLC (66.98%). Therefore, with high MIR emissivity, commercial paints with increased thickness can achieve similar or better outdoor cooling performance than BLCs. On the other hand, in some cases thin coatings are needful, our BLCs can still be more advantageous in outdoor cooling. Plus, conventional paints with high MIR emissivity are unfavorable for preventing heat loss during cold days, which can be achieved by BLCs.

### CONCLUSION

In summary, we reported a category of colorful low-emissivity paints that are designed to produce bilayer coatings simultaneously satisfying thermal effect as extra heat insulation through greatly reducing radiative thermal exchange and aesthetical effect for desired visual appearance. Through formulation optimization, the paints can readily generate spectrally selective coatings not only meeting demands in optical properties, but also showing fair hydrophobicity, environmental durability, color fastness and cleanability for practical application feasibility. The versatility of our colorful low-emissivity paints ensures they are suitable for extensive application scenarios. We expect these paints can be readily applied to help reduce both heat loss and gain through envelopes not sacrificing aesthetical appearance, which is significant for energy savings of space cooling and heating.

1. A bilayer coating for thermal management comprising:
a bottom layer composed of aluminum microflakes dispersed in a Nitrile Butadiene Rubber-co-Urea (NBR-U) polymer binder, wherein the bottom layer has an emissivity less than 0.4 and a reflectance larger than 0.6 in mid-IR wavelengths from 7 to 14 μm;
a top layer composed of nanoparticle pigments in the NBR-U polymer binder, wherein the top layer has a transmittance larger than 0.7 at IR wavelengths.

2. The bilayer coating of claim 1
wherein the aluminum flakes and the NBR-U polymer layer have a mass ratio in the bottom layer in the range from 100:1 to 100:1000.

3. The bilayer coating of claim 1
wherein the aluminum flakes and the NBR-U polymer layer have a mass ratio in the bottom layer in the range from 100:5 to 100:200.

4. The bilayer coating of claim 1
wherein the aluminum flakes and the NBR-U polymer layer have a mass ratio in the bottom layer substantially equal to 10:3.

5. The bilayer coating of claim 1
wherein the nanoparticle pigments and the NBR-U polymer layer have a mass ratio in the top layer in the range from 100:1 to 100:1000.

6. The bilayer coating of claim 1
wherein the nanoparticle pigments and the NBR-U polymer layer have a mass ratio in the top layer in the range from 100:10 to 100:200.

7. The bilayer coating of claim 1
wherein the nanoparticle pigments and the NBR-U polymer layer have a mass ratio in the top layer substantially equal to 100:50.

8. The bilayer coating of claim 1
wherein each of the aluminum microflakes has a lateral size in the range 100 nm to 1 mm and a thickness in the range 10 nm to 10 μm.

9. The bilayer coating of claim 1
wherein the bottom layer has a thickness between 5 and 10 μm.

10. The bilayer coating of claim 1
wherein the top layer has a thickness in the range 100 nm to 20 μm.

11. The bilayer coating of claim 1
wherein the nanoparticle pigments have a mean diameter in the range 10 nm to 10 μm.

12. The bilayer coating of claim 1
wherein the nanoparticle pigments have a mean diameter in the range 20 nm to 1 μm.
